(19) United States
(12) Patent Application Publication
(10) Pub. No.: US 2025/0113206 A1
(43) Pub. Date: Apr. 3, 2025

(54) PROVISIONING ACCESS POINT LOCATIONS AND UNIQUE IDENTIFIERS

(71) Applicant: Ekahau Inc., New York, NY (US)

(72) Inventors: Dan Marinescu-Gava, Helsinki (FI); Mikko Lauronen, Helsinki (FI); Rajasekar Mohan, Helsinki (FI); Anssi Tauriainen, Helsinki (FI)

(21) Appl. No.: 18/894,914

(22) Filed: Sep. 24, 2024

Related U.S. Application Data
(60) Provisional application No. 63/586,889, filed on Sep. 29, 2023.

(51) Int. Cl. H04W 16/18

(52) U.S. Cl. CPC H04W 16/18

(57) ABSTRACT

In accordance with embodiments, a device, system or method can be utilized during a validation survey of a region or premises to determine a location of an access point and to extract a unique identifier for the access point, synchronize the validation survey data, and then provision such data to a management system.

### CROSS-REFERENCE TO RELATED APPLICATION

This application claims priority to U.S. Provisional Patent Application No. 63/586,889, filed Sep. 29, 2023, which is hereby incorporated by reference in its entirety.

### FIELD

This disclosure relates generally to wireless networks and, more specifically, to deploying and monitoring access points for wireless networks. Other aspects are also described.

### BACKGROUND

A wireless digital communications network (wireless network) may include computing devices or nodes that communicate with each other using wireless data connections. Each node may have a radio transmitter and/or a radio receiver that communicates with the network over radio frequencies (RF). A wireless local area network (WLAN) links two or more devices through an access point (AP). The AP typically connects to a wired router, a switch, or a hub via an Ethernet cable to obtain access to the Internet. The AP projects a wireless signal (e.g., a Wi-Fi signal) which other nodes that are nearby receive, to communicate with the AP and thereby also give those nodes access to the Internet. A typical wireless network may include one or more APs that provide RF coverage to the nodes of the network over a given region. A multi-band AP has multiple radios, operating in different frequency bands.

A network planning tool is used to assist an owner or administrator of the wireless network to design the network by, for example, physically locating the APs in a facility (a given space) and configuring communication settings used by nodes of the wireless network. The network planning tool may obtain measurements made by a separate measurement tool. These are measurements of signals used for wireless communications in the network (RF measurements), and such measurements are then analyzed by the network planning tool to determine whether coverage is sufficient at various locations of the facility in which the wireless network is to be deployed. The network planning tool may help the user determine the number of APs as well as the physical locations of the APs to set the number of APs and their physical area of coverage. The user may, for example, wish to have as few APs as possible while providing a sufficiently large area of coverage.

### SUMMARY

Embodiments describe devices, systems and methods for provisioning access point locations and unique identifiers. In an embodiment, a device for provisioning access point locations and unique identifiers includes one or more radios, one or more sensors, at least one processor coupled to the one or more radios and the one or more sensors, a memory coupled to the at least one processor, the memory storing instructions that, when executed by the processor, cause the device to perform operations that include: detecting one or more signals being emitted in a region; determining whether the one or more detected signals is associated with an access point; for each determined access point, (1) extracting an access point identifier; and (2) determining a set of access point coordinates, the set of access point coordinates relating to a location of the access point in the region; and matching the extracted access point identifier with a corresponding established access point identifier associated with the region, wherein matching the extracted access point identifier includes linking the determined set of access point coordinates with the corresponding established access point identifier.

In an embodiment, a system for provisioning access point locations and unique identifiers includes a memory to store instructions and at least one processor to execute the instructions to: detect one or more signals being emitted in a region; determine whether the one or more detected signals is associated with an access point; for each determined access point, (1) extract an access point identifier; and (2) determine a set of access point coordinates, the set of access point coordinates relating to a location of the access point in the region; and match the extracted access point identifier with a corresponding established access point identifier associated with the region, wherein matching the extracted access point identifier includes linking the determined set of access point coordinates with the corresponding established access point identifier.

In embodiment, a method for provisioning access point locations and unique identifiers includes detecting one or more signals being emitted in a region; determining whether the one or more detected signals is associated with an access point; for each determined access point, (1) extracting an access point identifier; and (2) determining a set of access point coordinates, the set of access point coordinates relating to a location of the access point in the region; and matching the extracted access point identifier with a corresponding established access point identifier associated with the region, wherein matching the extracted access point identifier includes linking the determined set of access point coordinates with the corresponding established access point identifier.

### BRIEF DESCRIPTION OF THE DRAWINGS

FIG. 1 is an illustration of an example device for provisioning access point locations and unique identifiers, according to an embodiment.

FIG. 2 is an illustration of an example device, such as the device in FIG. 1, performing a validation survey of a region, according to an embodiment.

FIG. 3 is an illustration of an example device, such as the device in FIG. 1, performing a validation survey of a premises, according to an embodiment.

FIG. 4A is an illustration of an example management system before provisioning access point locations and unique identifiers, according to an embodiment.

FIG. 4B is an illustration of an example management system after provisioning access point locations and unique identifiers, according to an embodiment.

FIG. 5 is a flowchart of an example method for provisioning access point locations and unique identifiers, according to an embodiment.

### DETAILED DESCRIPTION

One of the most time-consuming and error-prone tasks of Wi-Fi Network Deployment is configuring the management system to display each AP correctly in the management system's dashboard. This is an important step because the management system, its auto-configuration functions and associated location services will not work properly unless each AP is correctly identified and located in the floor plan. This requires that the user knows the exact location, naming convention, and unique identifier (e.g., serial number, AP name, etc.) of each AP.

Traditionally, the user equipped with the above information would then have to manually upload each floor plan to the controller and input the geographical location information about the site. Once completed, the user can then proceed to find the APs from the inventory and drag and drop each individual AP one-by-one to its correct location on the map. It has been observed that this procedure can be very error-prone since serial numbers are long, the documentation must specify the exact location of the APs, and it must be repeated multiple times. For a large AP deployment (e.g., hundreds of APs, etc.), this procedure can be very time-consuming.

In accordance with embodiments, a device can be utilized during a validation survey of a region or premises that includes a provision system to determine a location of an access point and also extract a unique identifier for the access point (e.g., Basic Service Set Identifier or “BSSID,” AP name, etc.), synchronize the survey data, and then provision the survey data to a third-party management system. In this way, the access points for a particular region or premises can be automatically, and more accurately, provisioned to improve the functionality of the third-party management system and its associated location services.

In various embodiments, description is made with reference to figures. However, certain embodiments may be practiced without one or more of these specific details, or in combination with other known methods and configurations. In the following description, numerous specific details are set forth, such as specific configurations and processes, etc., in order to provide a thorough understanding of the embodiments. In other instances, well-known circuits, structures, and techniques have not been shown in detail so as not to obscure the understanding of this description. Reference throughout this specification to “one embodiment” means that a particular feature, configuration, or characteristic described in connection with the embodiment is included in at least one embodiment. Thus, the appearances of the phrase “in one embodiment” in various places throughout this specification are not necessarily referring to the same embodiment. Furthermore, the particular features, configurations, or characteristics may be combined in any suitable manner in one or more embodiments.

Further, one or more examples described herein may be implemented through the use of instructions that are executable by one or more processors. These instructions may be carried on a computer-readable medium. Devices shown or described with figures below provide examples of processing resources and computer-readable mediums on which instructions for implementing examples described herein can be carried and/or executed. In particular, the numerous devices shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

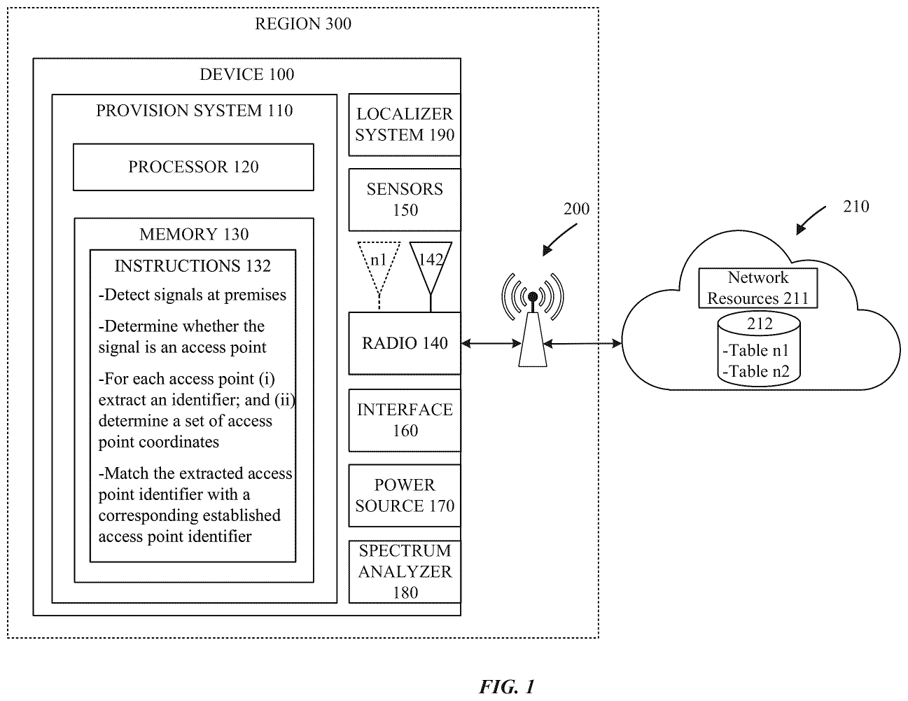

FIG. 1 illustrates an example device for provisioning access point locations and unique identifiers. Device 100 can be implemented as a dedicated device or in conjunction with multiple other devices (e.g., smartphone, tablet, etc.) to perform a wireless site survey or validation survey of the access points located at different types of premises (e.g., office building, school, hospital, etc.) or different types of regions within a premises (e.g., offices, classrooms, hospital rooms, etc.). Provision system 110 may be implemented using hardware, firmware and/or software. For example, provision system 110 can include one or more processors coupled to a memory where the one or more processors (e.g., central processing unit or “CPU,” etc.) execute a set of instructions stored on the memory (e.g., read-only memory or “ROM,” random access memory or “RAM,” etc.). In the example of FIG. 1, provision system 110 includes a processor 120 to execute a set of instructions 132 stored on memory 130.

In addition, device 100 may include multiple radios that may each include multiple antennas to interact with access points located throughout a region or premises. The multiple radios may sweep for active channels and determine the network signal strength at each of the different plurality of frequency ranges, where a first radio may detect the signal strength of one channel, a second radio may simultaneously detect the signal strength of another channel, and so on. Further, where a radio includes multiple antennas (e.g., omnidirectional antennas, etc.), the antenna signals of the multiple antennas may be combined such as by taking the average of the strongest of the antenna signals and using the combined signal for the measurement of the signal strength. A radio may also extract data (e.g., decode the signal) from each of the multiple antennas so that processor 120 may skip or ignore channels that are not deemed to have activity.

While it is contemplated that, in practice, device 100 may include multiple radios that each include multiple antennas, in the interest of clarity and conciseness the example device illustrated in FIG. 1 includes one radio (e.g., radio 140) with one antenna (e.g., antenna 142). In the example of FIG. 1, processor 120 can operate antenna 142 of radio 140 to determine whether a particular channel of a wireless network has activity. In response to a channel having activity, processor 120 may operate radio 140 to detect the signal strength of a particular channel. For example, in reference to FIG. 1, antenna 142 of radio 140 may scan region 300 and detect both desired RF signals from access point 200 as well as “noise” from other sources (e.g., non-network sources, different wireless networks, etc.), where an RF measurement can be derived from the signal-to-noise ratio (“SNR”). In one embodiment, based on such RF measurements, processor 120 can determine a location of an access point and then “tag” the location (e.g., Cartesian X-Y-Z coordinates, etc.), where the tagged location and its associated RF measurement can be stored locally (e.g., memory 130) or remotely (e.g., cloud network 210).

In addition, processor 120 can utilize antenna 142 of radio 140 to transmit or receive data packets between device 100 and an external device or computing system. In one example, processor 120 can cause data packets to be communicated between device 100 and access point 200. In another example, processor 120 can cause data packets to be communicated between device 100 and cloud network 210, where cloud network 210 may include network resources 211 (e.g., network interface, virtual machines, etc.) for enabling the receipt of data from an external device. Cloud network 210 may also include database 212 for storing data related to a wireless system (e.g., floor plans, non-provisioned AP inventory, provisioned AP inventory, etc.). In such examples, processor 120 can cause device 100 to communicate with cloud network 210 through a wi-fi network (e.g., through access point 200), through a cellular network or by some other means. In one embodiment, device 100 can communicate with access point 200 to determine a unique identifier of access point 200. For example, in reference to FIG. 1, antenna 142 of radio 140 may receive wireless packets from access point 200 (e.g., beacon frames, probe responses, authentication responses, etc.) or may send wireless transmissions to access point 200 (e.g., probe requests, authentication requests, association requests, etc.), where these communications can include values such as channels, data rates, and unique identifiers (e.g., Basic Service Set Identifier or “BSSID,” AP name, etc.) associated with access point 200. Based on such communications, processor 120 can determine a unique identifier of an access point (e.g., BSSID, AP name, etc.) and then tag the unique identifier, where the tagged unique identifier as well as its associated AP location can be stored locally (e.g., memory 130) or remotely (e.g., cloud network 210).

Device 100 can also include one or more sensors 150. One or more sensors 150 can include one or more cameras, LIDAR systems, time of flight (“TOF”) camera systems, gyroscopes, compasses, accelerometers, etc., to analyze a region or premises as well as the objects within the region or premises that may affect RF measurements (e.g., walls, windows, doors, floors, ceilings, furniture, etc.). In some embodiments, where a pre-existing floor plan is not available, provision system 110 can create a floor plan based on sensor data from the one or more sensors 150. For example, based on a LIDAR “scan” of a premises by the one or more sensors 150, provision system 110 can determine the presence of particular structures (e.g., walls, floors, ceilings, etc.) as well as the distances between such structures in order to generate a multi-dimensional model of the region or premises.

In addition, device 100 may include interface 160 which may include a button, a touchscreen display, a microphone, etc., to receive user inputs. Interface 160 may also include a wired or wireless port to connect device 100 to an external device that may provide such an interface (e.g., smartphone, tablet, etc.). Device 100 may also include a power source 170 (e.g., battery, etc.) so that a user may carry the device freely throughout a given region. Further, device 100 may include spectrum analyzer 180 to measure the magnitude of an input signal, such as RF signals from access point 200. In particular, spectrum analyzer 180 may determine whether a wireless transmitter is working according to defined standards for purity of emissions or to determine the bandwidth of a digital or analog signal. Further still, device 100 may include a localizer system 190 to determine a location of device 100. Localizer system 190 may include a Wi-Fi position system (“WPS”) that utilizes sensor information and/or sensed characteristics (e.g., signal strength) of various APs and known locations of each AP to determine a location of device 100. Additionally, or alternatively, the localizer system 190 may include a global positioning system (“GPS”) to determine the location of device 100. The location of device 100 may be used in association with the sensor information and/or the sensed RF measurements to map the RF measurements at various locations within a region or premises.

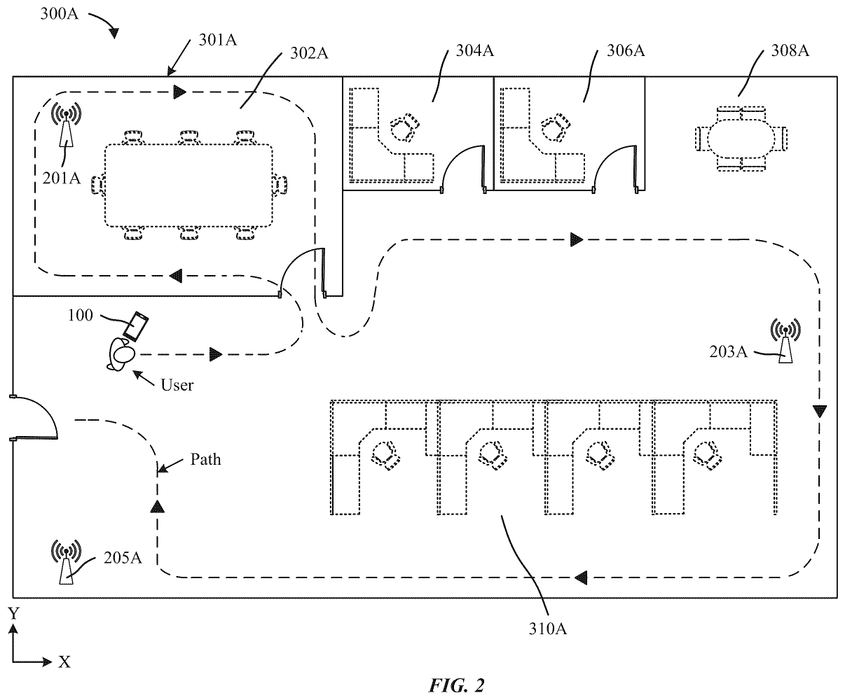

Referring now to FIG. 2, an example device (such as device 100 in FIG. 1) is shown performing a validation survey of region 300A. Region 300A includes structure 301A (e.g., walls, doorways, etc.), which divides region 300A into its respective areas. In the example of FIG. 2, region 300A includes conference room 302A, offices 304A and 306A, break room 308A and cubicle area 310A. During a validation survey, a user may traverse a path through region 300A and its respective areas. For example, a user may traverse the path to conference room 302A, where an antenna of device 100 (e.g., antenna 142 of radio 140, etc.) detects one or more signals, which can include desired RF signals from an access point as well as “noise” from surrounding sources. In some instances, the user may need to traverse back and forth along the path (or another route) to collect enough data to make the proper RF measurements. Further, the user may observe such signals (or other relevant data) via interface 160 of device 100, which can be included as part of device 100 or integrated as part of another device (e.g., smartphone, tablet, etc.). As device 100 detects the signals, processor 120 may determine whether the signals are associated with an access point. For example, processor 120 can analyze the signals detected by antenna 142 of radio 140 and data from spectrum analyzer 180 related to the characteristics of the signals in conference room 302A (e.g., frequency, bandwidth, etc.) to determine that the signals are associated with access point (“AP”) 201A.

Device 100 may then determine the location of AP 201A, as well as extract a unique identifier related to AP 201A. For example, based on the RF measurements from AP 201A (e.g., RF signal strength, etc.) as well as data from localizer system 190 (e.g., GPS data, WPS data, etc.) and/or from the one or more sensors 150 of device 100, processor 120 may determine the location of AP 201A in relation to device 100. Further, based on a floor plan of region 300A that may be uploaded to device 100 from database 212 of cloud network 210 prior to the validation survey, processor 120 may determine the location of both AP 201A and device 100 in relation to a floor plan of region 300A where the locations of AP 201A and device 100 can be correlated with or overlaid onto a digital representation of the floor plan (e.g., Cartesian X-Y-Z coordinates, etc.). In some embodiments the floor plan of a particular region may not be uploaded prior to the validation survey. In such instances, based on data from the one or more sensors 150 of device 100 (e.g., time-of-flight camera system, etc.), processor 120 can create a floor plan for the particular region and then utilize the created floor plan to correlate or overlay the determined locations of the various access points within the region. Further, device 100 can also extract a unique identifier associated with AP 201A. In the example of FIG. 2, based on the receipt of one or more data packets from AP 201A (e.g., beacon frame, etc.) or the transmission of a request to AP 201A from device 100 (e.g., probe request, etc.), processor 120 can extract a unique identifier, such as the BSSID or AP name, from AP 201A. In some embodiments, a unique identifier may not be extracted from AP 201A by the exchange of data packets between device 100 and AP 201A. In such instances, processor 120 can extract such data from an image of a label of AP 201A captured by the one or more sensors 150 of device 100 (e.g., camera, etc.) where accessible.

Further, the user can traverse the path out of conference room 302A and past offices 304A and 306A. Due to the omnidirectional character of its antennas, device 100 can simultaneously scan multiple areas within region 300A, such as offices 304A, 306A and cubicle area 310A even though the user may not have device 100 directed toward either of those areas. As shown in FIG. 2, upon completion of the survey, device 100 has discovered two additional access points, AP 203A located between break room 308A and cubicle area 310A, and AP 205A located between conference room 302A and cubicle area 310A. Further, AP 201A, AP 203A, and AP 205A can form an Extended Service Set (“ESS”), which can extend the signal strength and range of the wireless network within region 300A. In addition, while AP 201A, AP 203A, and AP 205A may advertise the same wireless network name (e.g., Service Set Identifier or “SSID”), each access point has its respective unique identifier, such as the BSSID which may be configured from the Media Access Control (“MAC”) address or physical address of each access point. Of note, an SSID for a wireless network may be distinguished from an AP name for an access point in that the AP name is a unique descriptive name (e.g., first floor conference room, etc.) often provided by an administrator when setting up a network and then advertised in Wi-Fi beacons. In this way, AP names, similar to BSSIDs, are unique identifiers that may be extracted from an access point by device 100.

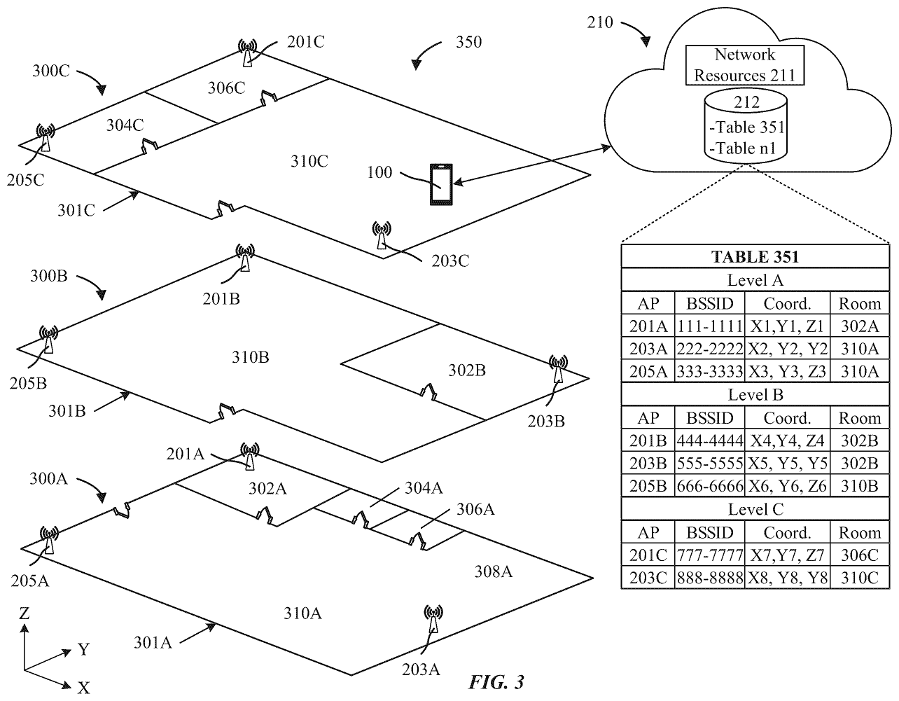

Referring now to FIG. 3, an example device (such as device 100 in FIG. 1) is shown performing a validation survey of premises 350. Premises 350 includes regions 300A (as described in FIG. 2), 300B and 300C. Similar to the embodiment described in FIG. 2 in which a user scanned region 300A to determine the location and unique identifiers associated with access points on that particular level, similarly here a user has performed validations surveys for both regions 300B and 300C. In the example of FIG. 3, regions 300B and 300C represent levels or floors of premises 350 that are located above region 300A. Region 300B includes conference room 302B and cubicle area 310B, which are segmented by structure 301B (e.g., walls, doorways, etc.), where device 100 determined the locations and unique identifiers of access points AP 201B, AP 203B, AP 205B. Specifically, AP 201B and AP 205B are located in cubicle area 310B, and AP 203B is located in conference room 302B. For region 300C, structure 301C segments the region into offices 304C, 306C and cubicle area 310C. Further, device 100 determined the locations and unique identifiers of access points AP 201C, AP 203C, AP 205C, with AP 201C located in office 306C, AP 203C located in cubicle area 310C, and AP 205C located in office 304C. In some embodiments, the floor or level designations for regions 300A, 300B, 300C can be entered manually through interface 160. In other embodiments, processor 120 can automatically determine the floor or level designations (e.g., Z-coordinate in Cartesian System) based on data analyzed by localizer system 190 and/or data from the one or more sensors 150.

Further, provision system 110 can tag the respective location data and unique identifier data for each access point located within premises 350. The tagged data can then be stored locally, or, as illustrated in the example of FIG. 3, processor 120 can cause the tagged data to be transmitted to cloud network 210, where it can be stored in database 212. In some embodiments, the data can be stored both locally on device 100 (e.g., memory 130) and remotely on cloud network 210 (e.g., database 212). In this way, the transmission of the tagged data from device 100 to cloud network 210 acts to “synch” the tagged data in both destinations. In the example of FIG. 3, the tagged data from premises 350 is stored in Table 351 on database 112 of cloud network 210. The data included in Table 351 includes the unique identifier (e.g., BSSID), Cartesian coordinates within premises 350 (e.g., X-Y-Z coordinates), as well as room location for each respective access point. It should be noted that the information contained in Table 351 is not exhaustive but merely representative of the type of data collected and stored by device 100 during a validation survey. For example, the data included in Table 351 may also include the AP name of each access point in addition to (or in place of) the BSSID for each access point.

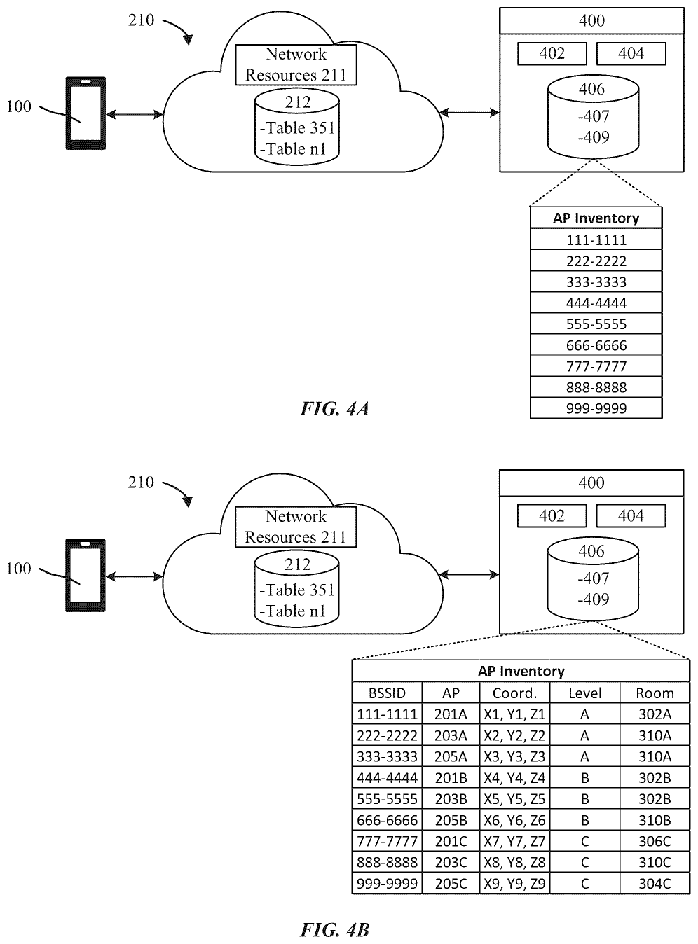

Referring now to FIG. 4A and FIG. 4B, FIG. 4A is an illustration of an example third-party management system before provisioning the validation survey data; FIG. 4B is an illustration of an example third-party management system after provisioning the validation survey data. Management systems, such as management system 400 in FIG. 4A, may provide a visual representation or “dashboard” of the performance metrics for a third-party organization (e.g., trends, efficiencies/inefficiencies, reports, etc.). Specifically, the data from the validation survey performed by device 100 represents performance metrics related to the third-party organization's Wi-Fi systems. In the example of FIG. 4A, management system 400 includes processor 402, memory 404 as well as other components necessary for connecting management system 400 to external devices, such as device 100. Further, management system 400 can include database 406, which can store data related to the third-party organizations Wi-Fi systems, among other data. For example, database 406 can store digital representations of floor plans 407, such as a floor plan for a region (e.g., region 300A), which may be uploaded to device 100 prior to performing a validation survey of the region. Further, database 406 can also include an AP inventory 409, which may include an inventory of all the access points deployed in the regions of a particular premises before provisioning. In the example of FIG. 4A, AP inventory 409 includes the identification of the access points but does not include their respective locations within premises 350. In such instances, where the inventory of access points does not include the specific locations of each access point within a particular premises, the monitoring and servicing of the Wi-Fi system at that premises can be difficult and time consuming, especially when the premises is large and includes thousands of access points.

Referring now to FIG. 4B, in some embodiments, processor 120 of provision system 110 can cause the survey data to be exported to processor 402 of management system 400 via the network resources 211 of cloud network 210, where the validation survey data can be matched or linked to the inventory data (e.g., AP inventory 409) and provisioned by management system 400. In other embodiments, processor 120 of provision system 110 can communicate with processor 402 of management system 400 to fetch its inventory data, such as AP inventory 409, so that the validation survey data can be matched or linked to the inventory data and provisioned by provision system 110. In such instances, even though provision system 110 performs the matching and the provisioning, provision system 110 can format the data in accordance with the provisioning application programming interface (“API”) of the third-party management system. Further, provision system 110 can also provide a graphical representation of the provisioned validation survey data utilizing the provisioning API of the third-party management system (e.g., heat map, etc.).

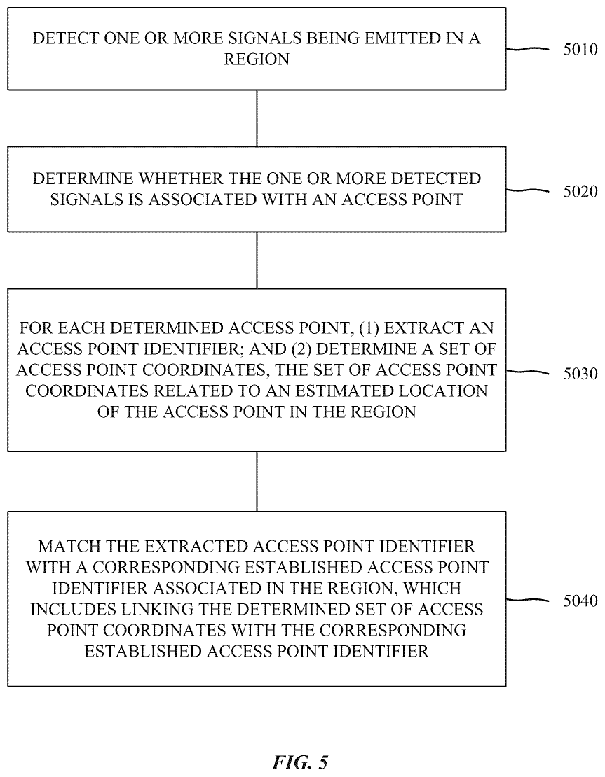

FIG. 5 illustrates an example method for provisioning access point locations and unique identifiers. At operation 5010, processor 120 of provision system 110 detects one or more signals being emitted in a region, where the one or more signals can include RF signals being emitted by an access point (e.g., AP 201A, etc.) as well as noise generated by non-broadcast electronic devices (e.g., electromagnetic interference) or unwanted RF signals broadcast by RF transmitters (e.g., RF interference). At operation 5020, processor 120 of provision system 110 may calculate a signal-to-noise ratio in order to determine whether the one or more detected signals is associated with an access point. At operation 5030, provision system 110 can extract a unique access point identifier based on data packets communicated between an access point and device 100. For example, such data packets can include channels, data rates, and unique identifiers (e.g., BSSID, AP name, etc.) related to access point 200. Further, provision system 110 can also determine the location of an access point based on the RF measurement of the access point as well as the location information of device 100 itself in relation to both the access point and the floor plan of the region. In some embodiments, the floor plan of a region (e.g., region 300A) can be uploaded from either a cloud network (e.g., database 212 of cloud network 210) or from a third-party management system (e.g., database 406 of management system 400). In other embodiments where the floor plan of a region is not available before conducting a validation survey, provision system 110 can create a digital representation of the floor plan of the region based a scan of the region by the one or more sensors 150 of device 100. At operation 5040, provision system 110 can match or link the extracted access point identifiers with a corresponding established access point identifiers for the region. In such instances, the established access point identifier may be stored locally on memory 130 of device 100 or remotely on either a cloud network (e.g., database 212 of cloud network 210) or on a third-party management system (e.g., database 406 of management system 400). In either case, provision system 110 can present the determined validation survey data related to the locations and unique identifiers associated with each access point of a region in accordance with a format or API of the third-party management system. In some instances, the survey data can also be graphically represented in accordance with the API of a third-party management system.

In utilizing the various aspects of the embodiments, it would become apparent to one skilled in the art that combinations or variations of the above embodiments are possible for provision the access points at a given region or premises. Although the embodiments have been described in language specific to features and/or methodological acts, it is to be understood that the appended claims are not necessarily limited to the specific features or acts described. The specific features and acts disclosed are instead to be understood as embodiments of the claims useful for illustration.

What is claimed is:

1. A method for provisioning access point locations, the method comprising:
detecting one or more signals being emitted in a region;
determining whether the one or more detected signals is associated with an access point;
for each determined access point, (1) extracting an access point identifier; and (2) determining a set of access point coordinates, the set of access point coordinates relating to a location of the access point in the region; and
matching the extracted access point identifier with a corresponding established access point identifier associated with the region, wherein matching the extracted access point identifier includes linking the determined set of access point coordinates with the corresponding established access point identifier.

2. The method of claim 1, wherein determining whether the one or more detected signals is associated with the access point includes analyzing packet capture data and RF measurements across one or more transmission frequencies.

3. The method of claim 1, wherein the extracted access point identifier includes a BSSID or AP name associated with the access point.

4. The method of claim 1, wherein the determined set of access point coordinates include a set of x, y coordinates for a particular level of a premises.

5. The method of claim 1, wherein the established access point identifier is provided by a third-party management system as part of a set of unique identifiers for each access point located in the region.

6. The method of claim 1, further comprising providing a map of a location of each access point within the region.

7. A device comprising:
one or more radios;
one or more sensors;
at least one processor coupled to the one or more radios and the one or more sensors;
a memory coupled to the at least one processor, the memory storing instructions that, when executed by the at least one processor, cause the device to perform operations that include:
detecting one or more signals being emitted in a region;
determining whether the one or more detected signals is associated with an access point;
for each determined access point, (1) extracting an access point identifier; and (2) determining a set of access point coordinates, the set of access point coordinates relating to a location of the access point in the region; and
matching the extracted access point identifier with a corresponding established access point identifier associated with the region, wherein matching the extracted access point identifier includes linking the determined set of access point coordinates with the corresponding established access point identifier.

8. The device of claim 7, wherein determining whether the one or more detected signals is associated with the access point includes analyzing packet capture data and RF measurements across one or more transmission frequencies.

9. The device of claim 7, wherein the extracted access point identifier includes a BSSID or AP name associated with the access point.

10. The device of claim 7, wherein the determined set of access point coordinates include a set of x, y coordinates for a particular level of a premises.

11. The device of claim 7, wherein the established access point identifier is provided by a third-party management system as part of a set of unique identifiers for each access point located in the region.

12. The device of claim 7, further comprising providing a map of a location of each access point within the region.

13. The device of claim 12, wherein providing the map of the location includes correlating a set of coordinates of a floor plan of the region with the determined set of access point coordinates.

14. A provision system for a device, the provision system comprising:
a memory to store instructions; and
at least one processor to execute the instructions to:
detect one or more signals being emitted in a region;
determine whether the one or more detected signals is associated with an access point;
for each determined access point, (1) extract an access point identifier; and (2) determine a set of access point coordinates, the set of access point coordinates relating to a location of the access point in the region; and
match the extracted access point identifier with a corresponding established access point identifier associated with the region, wherein matching the extracted access point identifier includes linking the determined set of access point coordinates with the corresponding established access point identifier.

15. The provision system of claim 14, wherein the at least one processor executes the instructions to determine whether the one or more detected signals is associated with the access point by analyzing packet capture data and RF measurements across one or more transmission frequencies.

16. The provision system of claim 14, wherein the extracted access point identifier includes a BSSID or AP name associated with the access point.

17. The provision system of claim 14, wherein the determined set of access point coordinates include a set of x, y coordinates for a particular level of a premises.

18. The provision system of claim 14, wherein the established access point identifier is provided by a third-party management system as part of a set of unique identifiers for each access point located in the region.

19. The provision system of claim 14, further comprising additional instructions that when executed by the at least one processor cause the system to provide a map of a location of each access point within the region.

20. The provision system of claim 19, wherein the at least one processor executes the additional instructions to provide the map by correlating a set of coordinates of a floor plan of the region with the determined set of access point coordinates.
